(19) United States
(12) Patent Application Publication
(10) Pub. No.: US 2018/0353364 A1
(43) Pub. Date: Dec. 13, 2018

(54) MEDICAL CHAIR BACKREST SLIDING STRUCTURE

(71) Applicant: COZYELL Co., Ltd., Incheon (KR)

(72) Inventor: Eun-Ha PARK, Siheung-si (KR)

(73) Assignee: COZYELL Co., Ltd., Incheon (KR)

(21) Appl. No.: 15/577,484

(22) PCT Filed: Dec. 3, 2015
(86) PCT No.: PCT/KR2015/013101

§ 371 Date: Nov. 28, 2017

(30) Foreign Application Priority Data
Jul. 22, 2015 (KR) 10-2015-0103980

(51) Int. Cl. A61G 15/02; A61G 15/12

(52) U.S. Cl. CPC A61G 15/02; A61G 15/12

(57) ABSTRACT

The present invention relates to a medical chair backrest sliding structure and, more specifically, to a medical chair backrest sliding structure, which allows a sensitive procedure such as plastic surgery to be carried out stably by enabling the backrest to move, when adjusting the angle of a backrest, in the vertical direction, in a state in which the backrest makes contact with the back of a patient, such that even if the angle of the backrest is adjusted the movement of the patient is prevented. To achieve the above mentioned objective, the present invention relates to the medical chair backrest sliding structure comprising: a backrest hinge-coupled with a seat plate; a chair leg-portion provided to a lower part of the seat plate; and an angle adjustment portion for adjusting the angle of the backrest, wherein the back part of the backrest comprises a backrest frame hinge-coupled to the seat plate, the backrest moves vertically along the backrest frame, the backrest frame includes one pair of LM guides, and an LM block, which moves along the LM guides, is provided on a rear surface of the backrest.

### TECHNICAL FIELD

The present invention relates to a medical chair backrest sliding structure and, more specifically, to a medical chair backrest sliding structure, which allows a sensitive procedure such as plastic surgery to be carried out stably by enabling the backrest to move, when adjusting the angle of a backrest, in the vertical direction, in a state in which the backrest makes contact with the back of a patient, such that, even if the angle of the backrest is adjusted, the movement of the patient is prevented.

### BACKGROUND ART

Generally, a medical chair for treating (or operating on) a patient is configured such that a backrest and a footrest are folded about a seat section, on which a patient is seated, in a mutually-cooperative manner, to allow a doctor to easily observe a target part of a patient when treating (or operating on) the patient.

The medical chair also includes a lifting unit and a rotary unit to height-adjust and rotate the medical chair depending on a body condition of a patient or a doctor.

The conventional lifting unit of the medical chair is configured using a gear mechanism such that a rack gear is installed on a support shaft mounted to a base plate of the chair, and a driving gear is driven along the rack gear by a motor mounted onto an undersurface of a seat plate, so as to move up and down the medical chair.

In order to adjust the reclining angle of the backrest, the backrest and the seat plate are coupled using a hinge, and a fastening part is provided to the hinge to regulate the reclining angle to a specified value in a manual control mode or an automatic control mode using a motor, a cylinder, or the like.

As an example of the medical chair, as illustrated in FIGS. 1 to 3, a conventional medical chair is disclosed in Korean Registered Patent No. 10-0281025. The disclosed medical chair c is provided to have functions to allow the vertical movement and horizontal rotation of the seat section and the tilting movement of the backrest and the footrest in order to treat or operate on a patient more conveniently. In the medical chair, a backrest 2 is substantially vertically mounted to a rear side of a seat 1 so as to be coupled to a front end of a seat frame 1a by means of a hinge 5. A chair pedestal 7 is provided under the seat frame 1a of a seat portion s coupling a support 5 for footrest 4 to a front end of the seat 1 by means of a hinge 3a. The chair pedestal 7 has a stage 6 that protrudes in a circular shape at a specified height. A circular rotary part 7a is provided on an upper portion of the chair pedestal 7 such that a top-opened cylindrical support insertion tube is integrally provided to have a specified height on the circular rotary part 7a. Limits switches are provided on upper and lower portions on one side of an inner surface of the support insertion tube. On a lower side from the middle portion of the support insertion tube, a pulley is shaft-coupled, centrally passing through the circular rotary part 7a, and on an upper side thereof, a female screw tube 43 having an internal screw part on an inner surface thereof is vertically provided in which the male screw shaft having an outer screw part to be engaged with the internal screw part. The female screw tube has four vertical guide rails on the outer surface thereof. An upper plate 9 of a vertical support post 8 and a lower surface of the seat frame 1a are fixedly connected. A bi-directional motor 41 shaft is coupled to a front bottom portion of the seat frame 1a by means of a hinge 40a, wherein the motor shaft is formed as a male screw shaft 42. Another leading end of the female screw tube 43 having an inner screw part to be cooperatively engaged with the male screw shaft 42 is coupled to a lower end of the backrest 2 by means of a hinge 40b. A rod 46 is provided to an upper side of the hinge 40b. One end of the rod is coupled by means of a hinge 40d, and another leading end of the rod 46 is connected to an actuation bar 44 such that an upper leading end thereof is coupled to a leading end of the seat frame 1a by means of a hinge 40c, a leading end of an actuation part 45 vertically protruding at a middle portion thereof is coupled by means of a hinge 40e, and a lower leading end of the actuation bar 44 is connected to a lower side of the footrest 5.

Although the technique disclosed in Korean Registered Patent No. 10-0281025 has advantages capable of easily regulating the height, the direction, and angle of the backrest while a patient is sitting on the chair, thereby facilitating performing easy treatment or operation on the patient, the technique also requires frequent regulation of the angle of the backrest during performing a sensitive operation such as plastic surgery. In this case, there is a difference in unfolded degree between the backrest and the patient's waist when regulating the angle of the backrest, thereby problematically causing the patient to be moved so that the target part of the patient is affected by the movement of the patient, which makes it impossible to stably perform an operation.

### DISCLOSURE

### Technical Problem

Accordingly, the present invention has been made keeping in mind the above problems occurring in the related art, and an object of the present invention is to provide a backrest sliding structure for a medical chair, wherein the medical chair includes a leg support, a seat section, a backrest section, and an angle-adjusting unit for treatment or operation on of a patient, wherein a main frame part is provided under the seat section, and a backrest frame section is provided to the back of the backrest section so as to be hinge-coupled to an end of the main frame part, wherein the backrest frame section includes a pair of LM guide parts, and the backrest section is provided with an LM block part vertically movable along the LM guide part. Thus, even when the angle of the backrest section is regulated while a patient is sitting on the medical chair, the backrest section vertically moves in a state of being put against the patient, thereby preventing the patient from being moved. This facilitates stably performing a precise operation such as plastic surgery.

Another object of the present invention is to provide a backrest sliding structure for a medical chair, wherein upper and lower rotary shafts are respectively provided on upper and lower portions of a pair of LM guide parts constituting a backrest frame section, wherein first and second pulleys are respectively provided on the upper and lower rotary shafts, the first and second pulleys being connected via a belt or chain, wherein the back of the backrest section is connected to one side of the belt or chain, and a balance weight is attached to the other side of the belt or chain, the balance weight having the same weight as the backrest section, thereby allowing the backrest section to easily move even with little force and to, when no force is applied, stably maintain a current position by the action of the balance weight.

### Technical Solution

In order to accomplish the above object, the present invention provides a backrest sliding structure for a medical chair.

The medical chair includes a backrest section hinge-coupled to a seat section, and an adjusting unit adjusting an angle of a leg support provided on a lower side of the seat section and the backrest section, the structure including a backrest frame section attached to the back of the backrest section so as to be hinge-coupled to the seat section, such that the backrest section is vertically movable along the backrest frame section.

The backrest frame section may include a pair of linear motion (LM) guide parts, wherein the backrest section is provided on the back thereof with a LM block part movable along the LM guide part.

Upper and lower rotary shafts may be respectively provided on upper and lower portions of the LM guide part, wherein first and second pulleys are respectively provided on the upper and lower rotary shafts, the first and second pulleys being connected via a belt or chain.

The backrest section may be connected to one side of the belt or chain, and a balance weight may be attached to the other side of the belt or chain.

The balance weight may have the same weight as the backrest section.

An auxiliary LM guide part may be provided between the LM guide parts, wherein the balance weight is provided with an auxiliary LM block part movable along the auxiliary LM guide part.

The balance weight may be provided on opposite lateral sides thereof with coupling parts, respectively, to couple the belts of chains provided on the opposite lateral sides of the balance weight.

### Advantageous Effects

As described above, the present invention provides the backrest sliding structure for a medical chair, wherein the medical chair includes a leg support, a seat section, a backrest section, and an angle-adjusting unit for the treatment or operation of a patient, wherein the main frame part is provided under the seat section, and the backrest frame section is provided to the back of the backrest section so as to be hinge-coupled to an end of the main frame part, wherein the backrest frame section includes the pair of LM guide parts, and the backrest section is provided with the LM block part vertically movable along the LM guide part, so that, even when the angle of the backrest section is regulated while a patient is sitting on the medical chair, the backrest section vertically moves in a state of being put against the patient, thereby preventing the patient from being moved and thus facilitating stably performing a precise operation such as plastic surgery.

Further, the present invention provide the backrest sliding structure for a medical chair, wherein upper and lower rotary shafts are respectively provided on upper and lower portions of the pair of LM guide parts constituting a backrest frame section, wherein first and second pulleys are respectively provided on the upper and lower rotary shafts, the first and second pulleys being connected via a belt or chain, wherein the back of the backrest section is connected to one side of the belt or chain, and the balance weight is attached to the other side of the belt or chain, the balance weight having the same weight as the backrest section, thereby allowing the backrest section to easily move even with little force and to, when no force is applied, stably maintain a current position by the action of the balance weight.

### DESCRIPTION OF DRAWINGS

FIG. 1 is a perspective view of a conventional medical chair.

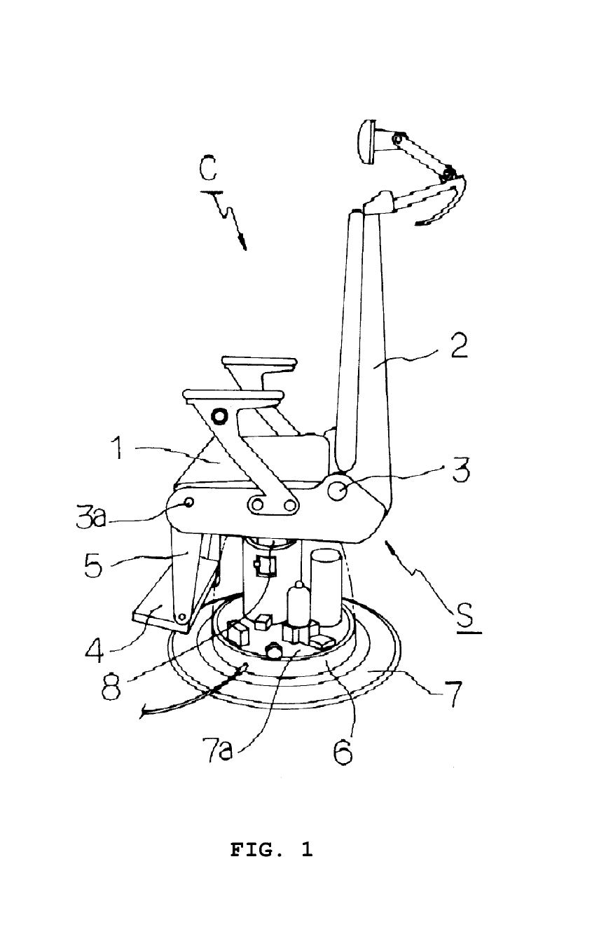

FIG. 2 is an enlarged view of a backrest angle-adjusting unit of the conventional medical chair.

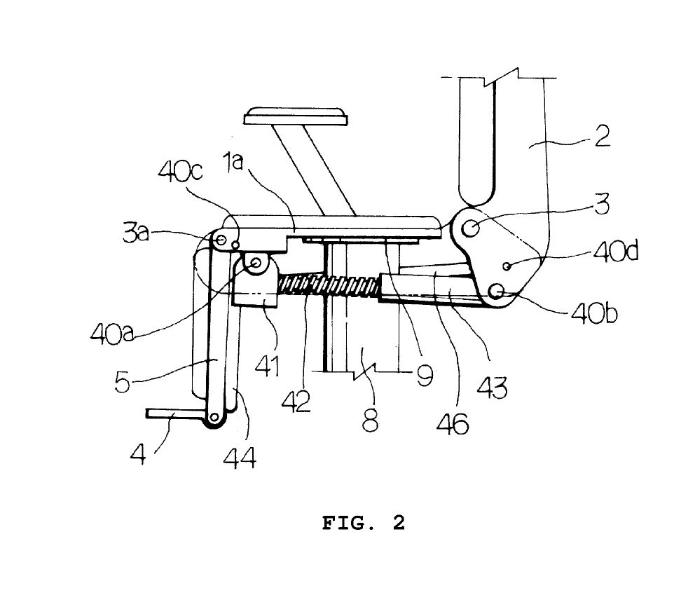

FIG. 3 is an enlarged view of the backrest angle-adjusting unit in an unfolded state.

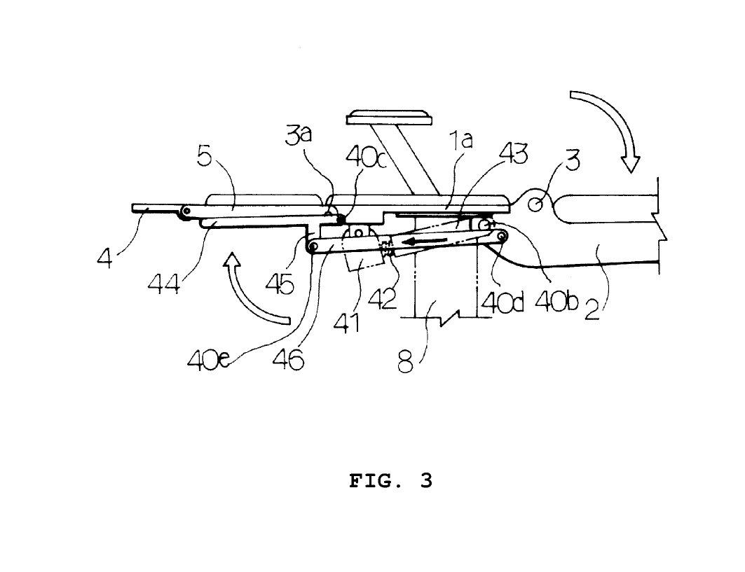

FIG. 4 is a side view of a medical chair to which a backrest sliding structure is applied according to the present invention.

FIG. 5 is a bottom view of the medical chair to which the backrest sliding structure is applied according to the present invention.

FIG. 6 is an enlarged view of the backrest sliding structure of the medical chair according to the present invention.

FIG. 7 is a side view of the backrest sliding structure of the medical chair with the backrest reclined according to the present invention.

FIG. 8 is a view of the medical chair to which the backrest sliding structure is applied according to the present invention, illustrating a level distance between a headrest of the backrest and a patient's head when the reclining angle of the medical chair is adjusted.

### BEST MODE

Hereinafter, preferred embodiments of the present invention will be described in detail with reference to the accompanying drawings. Like reference numerals are used for like elements throughout the drawings, and repeated description for like elements will be omitted. It should also be understood that the present invention may be implemented into other different forms, and is not limited to the described embodiments.

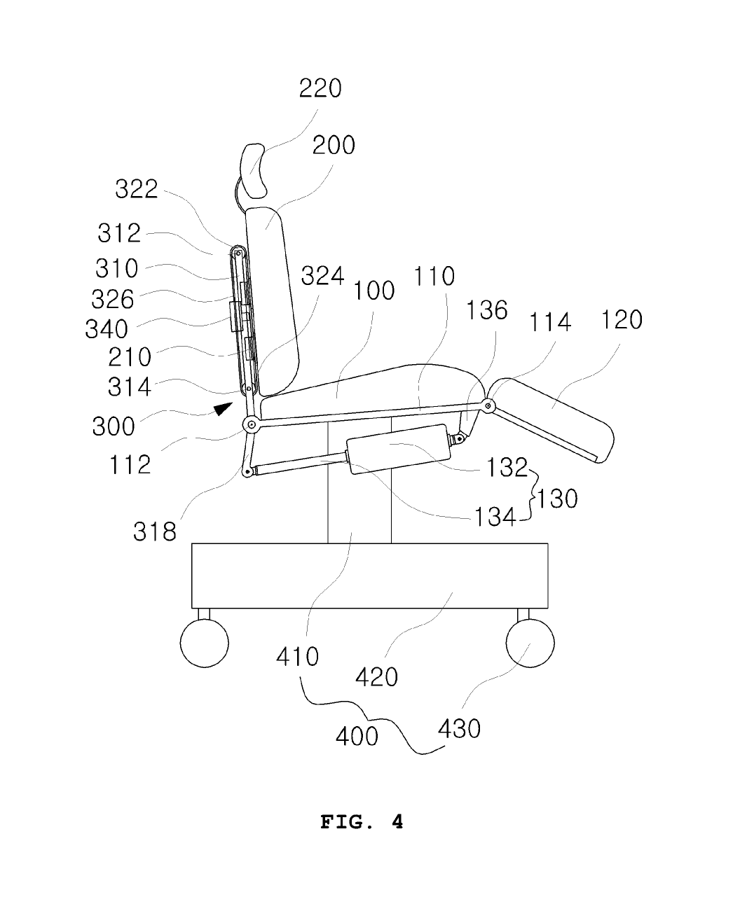

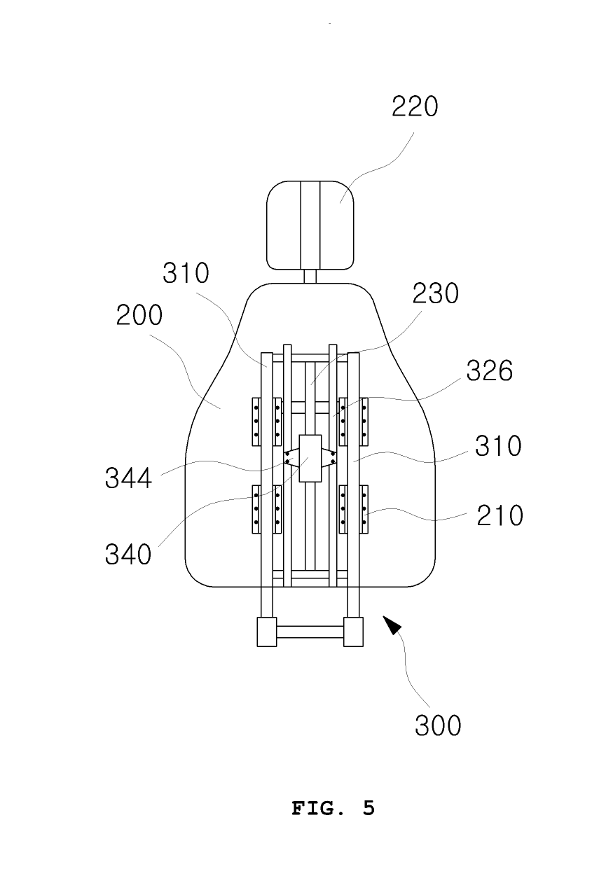

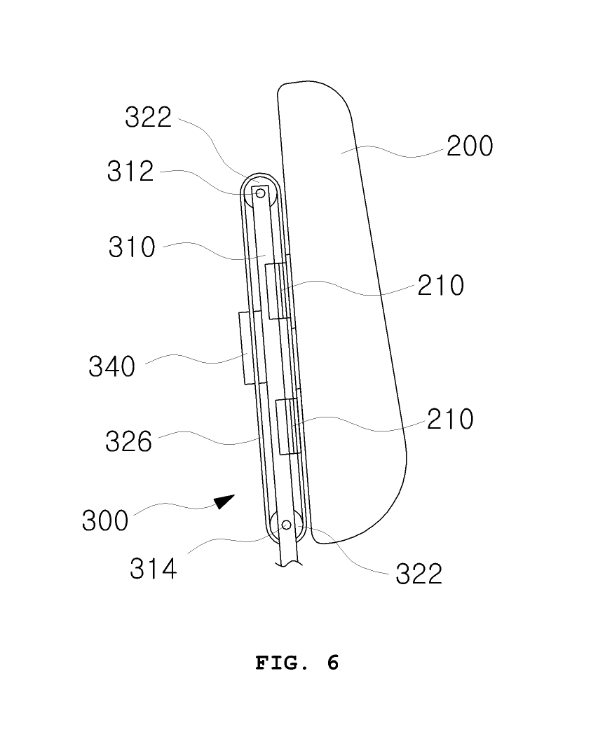

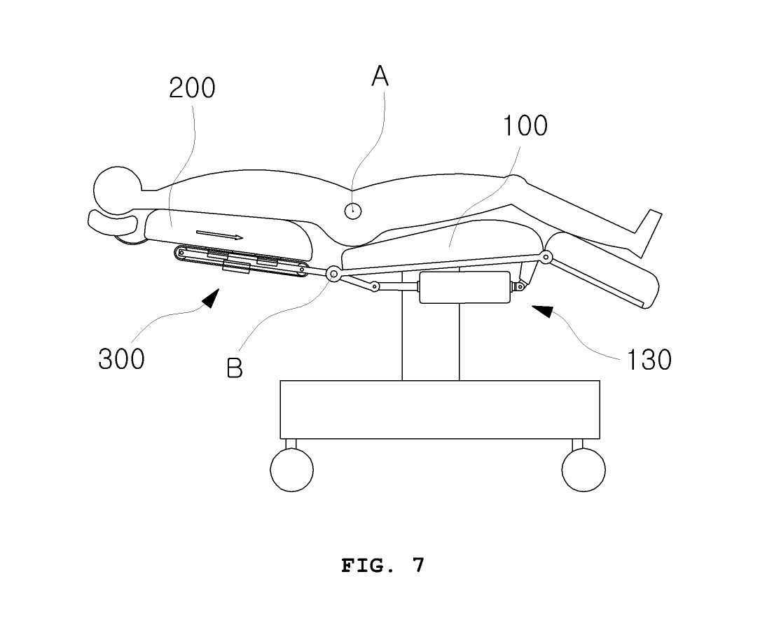

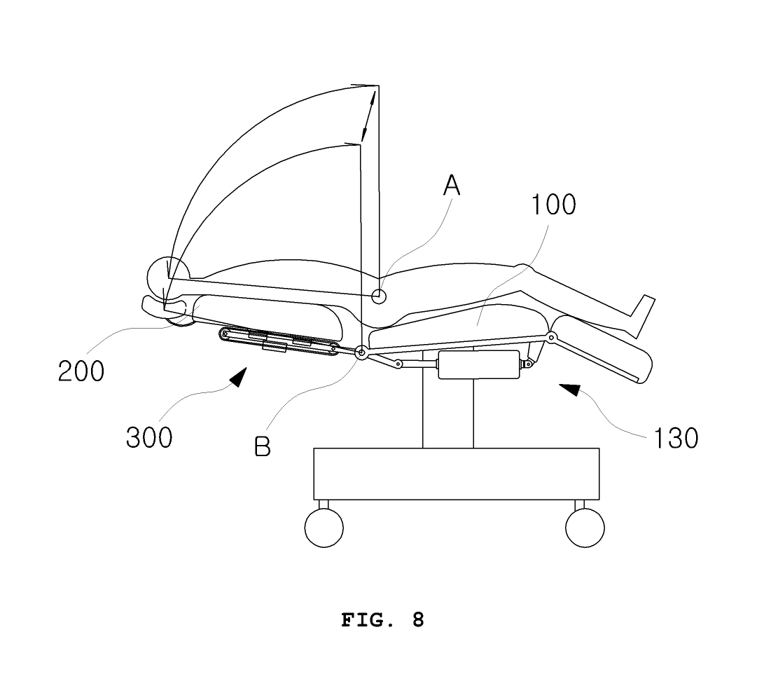

FIG. 4 is a side view of a medical chair to which a backrest sliding structure is applied according to the present invention, FIG. 5 is a bottom view of the medical chair to which the backrest sliding structure is applied according to the present invention, FIG. 6 is an enlarged view of the backrest sliding structure of the medical chair according to the present invention, FIG. 7 is a side view of the backrest sliding structure of the medical chair with the backrest reclined according to the present invention, FIG. 8 is a view of the medical chair to which the backrest sliding structure is applied according to the present invention, illustrating a level distance between a headrest of the backrest and a patient's head when the reclining angle of the medical chair is adjusted.

As illustrated in FIGS. 4 to 6, the present invention relates to a backrest sliding structure of a medical chair for allowing a backrest section 200 to move up and down when a reclining angle of the backrest section 200 is regulated. The medical chair includes a seat section 100 provided on an upper portion of a leg section 400, the backrest section 200 hinge-coupled to the seat section 100, and an adjusting unit 130 for adjusting a reclining angle of the backrest section. The backrest sliding structure is configured such that a backrest frame section 300 is mounted to the back of the backrest section 200 so as to be hinge-coupled to the seat section 100, such that the backrest section 200 is vertically movable along the backrest frame section 300.

Here, the backrest frame section 300 may be hinge-coupled directly to one side of the seat section 100, or otherwise may be hinge-coupled to a first hinge part 112 provided on one end side of a main frame part 110 provided to support the seat section 100 thereon as illustrated in the drawings.

The backrest frame section 300 includes a pair of linear motion (LM) guide parts 310 that vertically extends to support opposite sides of the backrest section 200.

Here, on the back of the backrest section 200, linear motion (LM) block parts 210 are mounted in such a manner as to be vertically movable along the LM guide parts 310, so that the backrest section 200 can easily move in a vertical direction along the backrest frame section 300 using the LM guide parts 310 and the LM block parts 210.

The LM guide part 310 is provided on upper and lower portion thereof with rotary shafts 312 and 314 to connect the LM guide part 310, wherein first and second pulleys 322 and 324 are rotatably mounted to the rotary shafts 312 and 314, respectively.

Here, the first and second pulleys 322 and 324 are internally provided with bearings (not shown) for stable rotation thereof, and a belt or chain 326 is mounted to the first and second pulleys 322 and 324 provided on the upper and lower portion of the LM guide part 310.

Here, the backrest section 200 is connected to one side of the belt or chain 326 and a balance weight 340 is attached to the other side of the belt or chain 326, wherein the balance weight 340 has the same weight as the backrest section 200.

Thus, when no force is applied, the backrest section 200 coupled to one side of the belt or chain 326 does not move, but stays at a current position by the action of the balance weight 340 provided on the opposite side of the belt or chain relative to the first and second pulleys 322 and 324.

When even little force is applied downwards or upwards, the backrest section can easily move upwards or downwards along the LM guide parts 310.

Considering the conventional case of regulating the reclining angle of the backrest section 200 of the medical chair on which a patient is seating for treatment or an operation, with reference to FIG. 8, since the backrest section 200 rotates about the first hinge part 112 coupled to the seat section 100 whereas the patient is bent about his/her waist, rotary points A and B are different. Thus, when the reclining angle of the backrest section 200 is regulated, the patient's back and the backrest section 200 become misaligned so that the patient's position is changed on the backrest section 200, thereby causing the patient to be slightly moved due to the frictional movement of the patient on the backrest section 200.

Here, while such slight movement does not substantially affect the patient during soft treatment or operation on the patient, in the case of during plastic surgery for example, it may cause the target part of the patient to be deformed, making it difficult to perform a precise operation on the patient.

Further, during facial plastic surgery, for example, since a plastic surgeon performs an operation on the face of a patient, unfolding the backrest section 200 while repeatedly standing up the backrest section 200 for checking and adjusting the position and shape of the target facial parts of the patient in a stand-up state is performed, thereby necessitating frequent angle adjustment of the backrest section 200, which may prevent a precise operation due to frequent movement of the patient.

According to the present invention, since the backrest section 200 can be vertically movable along the backrest frame section 300, as illustrated in FIG. 7, even when there is a difference in rotary points between the backrest section 200 and the patient, the backrest section 200, against which the patient's back is rested, is vertically movable along the LM guide parts 310 even with a slight force applied. This prevents the patient from being moved, thereby enabling a stable operation to be performed.

As illustrated in FIG. 4, the angle adjusting unit 130 includes an actuation member 132, one end of which is hinge-coupled to a bracket 136 provided on a lower portion of the main frame part 110 on which the seat section 100 is mounted, and an actuating rod 134 extendible from the actuation member 132. The actuation rod 134 is hinge-coupled to an end of an extension 318 provided on a lower side of the backrest frame part 310.

Here, since the extension 318 extends downwards from the first hinge part 112 provided on the lower side of the main frame part 110, when the actuation rod 134 extends or retracts by the action of the actuation member 132, the extension 318 rotates about the first hinge part 312 so as to allow the backrest frame part 310 provided above the extension 318 to rotate about the first hinge part 112 in the opposite direction to the extension 318, thereby regulating the reclining angle of the backrest section 200.

Here, a leg support member 120 is hinge-coupled to the other side of the seat section 100 to support patient's legs. The leg support member 120 can also be angle-adjusted, so that, when the leg support member 120 is unfolded together with the backrest section 100 as shown in FIG, 7, the patient can stand completely lying on the unfolded chair.

Here, the leg support member 120 may be hinge-coupled directly to the other side of the seat section 100, or may otherwise be hinge-coupled to a second hinge part 114 provided on a lower side of the main frame part 110 provided to support the seat section 100 thereon as shown in FIG. 4.

The reclining angle of the backrest section 200 may be performed by using the above-mentioned structure or other known structures.

The rotary shafts 312 and 314 are respectively provided with the first and second pulleys 322 and 324. Although the first and second pulleys 322 and 324 are respectively provided to the rotary shafts 312 and 314, and the belt or chain 326 is provided to the first and second pulleys, as shown in FIG. 5, the first and second pulleys 322 and 324 may be respectively provided in a pair, and the belt or chain 326 may also be provided in a pair.

Here, when only a single belt or chain 326 is provided, the balance weight 340 may be provided directly to the belt or chain 326. However, when the belt or chain is provided in a pair as shown in FIG. 5, the balance weight is horizontally positioned between the belts or chains 326, and coupling parts 344 are respectively provided on opposite laterals sides of the balance weight 340 so as to couple the belts or chains on the opposite lateral sides of the balance weight 340.

Here, since the back of the backrest section 200 is coupled to the other side of the pair of the belts or chains 326, the backrest section 200 can easily move up and down even with little force.

An auxiliary LM guide part 230 is provided between the pair of LM guide parts 310 to allow the vertical movement of the balance weight 340 along the auxiliary LM guide part. The auxiliary LM guide part 230 is fixedly mounted to the back of the backrest section 200, and the balance weight 340 is provided with an auxiliary LM block part (not shown) movable along the auxiliary LM guide part 230.

Thus, even when the backrest section 200 is completely unfolded by regulating the angle-adjusting unit 130 as shown in FIG. 7, the balance weight 340 and the belt or chain 326, to which the balance weight 340 is coupled, are prevented from hanging down due to the weight of the balance weight 340 with the provision of the auxiliary LM block part (not shown) connected to the auxiliary LM guide part 230, thereby preventing the belt or chain 326 from being damaged.

Although a preferred embodiment of the present invention has been described for illustrative purposes, the scope of the present invention is not limited thereto, and covers substantial equivalents to the disclosed embodiments. Those skilled in the art will appreciate that various modifications, additions and substitutions are possible, without departing from the scope and spirit of the invention.

What is claimed is:

1. A backrest sliding structure for a medical chair, wherein the medical chair comprises a backrest section hinge-coupled to a seat section, and an adjusting unit adjusting an angle of a leg support provided on a lower side of the seat section and the backrest section, the structure comprising:
a backrest frame section attached to the back of the backrest section so as to be hinge-coupled to the seat section, such that the backrest section is vertically movable along the backrest frame section.

2. The backrest sliding structure for a medical chair according to claim 1, wherein the backrest frame section includes a pair of linear motion (LM) guide parts, wherein the backrest section is provided on the back thereof with a LM block part movable along the LM guide part.

3. The backrest sliding structure for a medical chair according to claim 2, wherein upper and lower rotary shafts are respectively provided on upper and lower portions of the LM guide part, wherein first and second pulleys are respectively provided on the upper and lower rotary shafts, the first and second pulleys being connected via a belt or chain.

4. The backrest sliding structure for a medical chair according to claim 3, wherein the backrest section is connected to one side of the belt or chain, and a balance weight is attached to the other side of the belt or chain.

5. The backrest sliding structure for a medical chair according to claim 4, wherein the balance weight has the same weight as the backrest section.

6. The backrest sliding structure for a medical chair according to claim 4, wherein an auxiliary LM guide part is provided between the LM guide parts, wherein the balance weight is provided with an auxiliary LM block part movable along the auxiliary LM guide part.

7. The backrest sliding structure for a medical chair according to claim 6, wherein the balance weight is provided on opposite lateral sides thereof with coupling parts, respectively, to couple the belts or chains provided on the opposite lateral sides of the balance weight.
